(19) United States
(12) Patent Application Publication
(10) Pub. No.: US 2005/0184868 A1
(43) Pub. Date: Aug. 25, 2005

(54) System and method for detecting tampering in a gaming machine

(75) Inventors: Victor Mercado, Berwyn, IL (US); Stephen A. Canterbury, Antioch, IL (US)

Correspondence Address: SCHWEGMAN, LUNDBERG, WOESSNER & KLUTH, P.A., P.O. BOX 2938, MINNEAPOLIS, MN, 55402-0938, US

(73) Assignee: WMS Gaming Inc.

(21) Appl. No.: 10/782,693

(22) Filed: Feb. 19, 2004

(51) Int. Cl. G08B 13/08

(52) U.S. Cl. 340/545.3

(57) ABSTRACT

This document discusses, among other things, a system, method and kit for detecting tampering within a self-service machine having a housing. An emitter and a sensor are mounted to the housing and to an object positioned in relationship to the housing such that radiation generated by the emitter falls on the sensor when the object is in a particular position with respect to the housing and to a lesser extent otherwise. A signal is generated and the emitter is driven with the signal. The signal is modified and the sensor is monitored for the modified version of the signal. An alarm is generated if the modified version of the signal is not detected.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2003, WMS Gaming, Inc. All Rights Reserved.

### TECHNICAL FIELD

This patent application pertains generally to tamper detection, and more particularly, but not by way of limitation, to a system and method for detecting tampering in a gaming machine.

### BACKGROUND

Tamper resistance and intrusion detection are critical in self-service machines such as vending, video and gaming machines. Most such machines include a door interlock switch which detects when a door has been opened that exposes the game mechanism or the coin box to tampering. Such switches have been found to be easily defeated, exposing the internal workings of the machine without sounding an alarm or recording the unauthorized access.

U.S. Pat. No. 4,583,082, issued Apr. 15, 1986 to Naylor, discloses an optical door interlock in which a light emitter and sensor are mounted on a housing and a housing door. When the door is opened, the transfer of light from the emitter to the sensor is interrupted and an alarm is sounded. According to Naylor, it is not enough to simply detect the presence or absence of light at the sensor; such an approach is easily foiled to give a false indication of a closed door. Instead, Naylor describes a circuit which pulses the emitter with a sequence of pulses and then tracks an output of the sensor to make sure that the sensor is receiving radiation that tracks the sequence of pulses. Unfortunately, systems such as those described by Naylor are susceptible to being bypassed by, for instance, shorting the input of the emitter to the output of the sensor. What is needed is a system and method for detecting tampering in a self-service machine that avoids these problems and others raised in the description below.

In addition, today's self-service machines often reflect a large investment in time and money. It can be difficult and expensive to add security features, requiring significant investments in the underlying software. What is needed is a system and method for adding tamper detection to existing self-service machines.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1. illustrates a self-service machine according to the present invention;

FIGS. 2 and 3 illustrate tamper detection mechanisms according to the present invention;

FIGS. 4-6 illustrate self-service machines fitted with tamper detection mechanisms according to the present invention.

### DETAILED DESCRIPTION

In the following detailed description, reference is made to the accompanying drawings which form a part hereof, and in which is shown by way of illustration specific embodiments in which the invention may be practiced. These embodiments, which are also referred to herein as “examples,” are described in sufficient detail to enable those skilled in the art to practice the invention, and it is to be understood that the embodiments may be combined, or that other embodiments may be utilized and that structural, logical and electrical changes may be made without departing from the scope of the present invention. The following detailed description is, therefore, not to be taken in a limiting sense, and the scope of the present invention is defined by the appended claims and their equivalents.

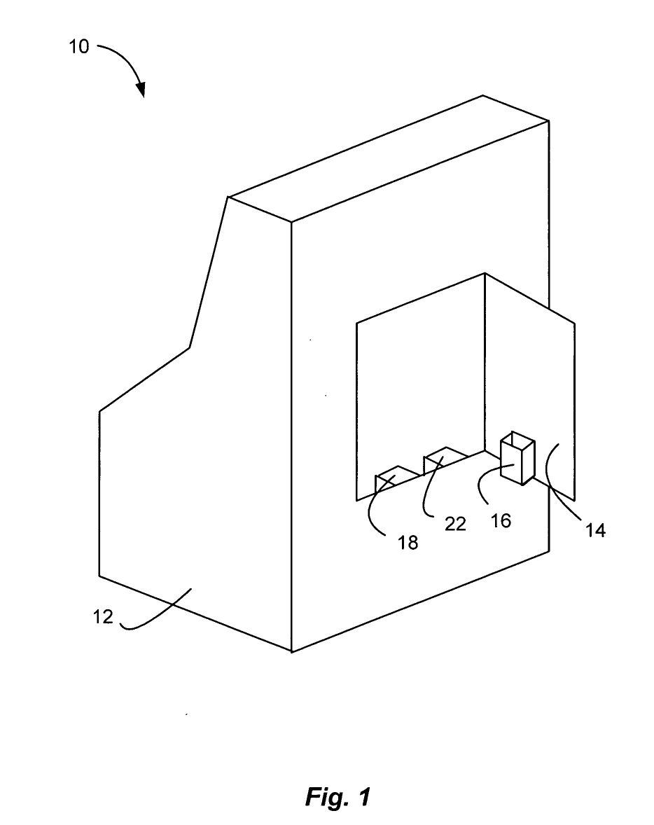

A self-service machine 10 such as a vending, gaming or video machine is shown in FIG. 1. In the example shown in FIG. 1, machine 10 includes a housing 12, a door 14, and a tamper detection mechanism including an emitter 16 and a sensor 18. In the example shown, emitter 16 is mounted on door 14 while sensor 18 is mounted on housing 12 but emitter 16 and sensor 18 could be mounted as well to housing 12 and door 14, respectively.

Emitter 16 and sensor 18 are positioned such that, when door 14 is closed, light from emitter 16 falls on sensor 18.

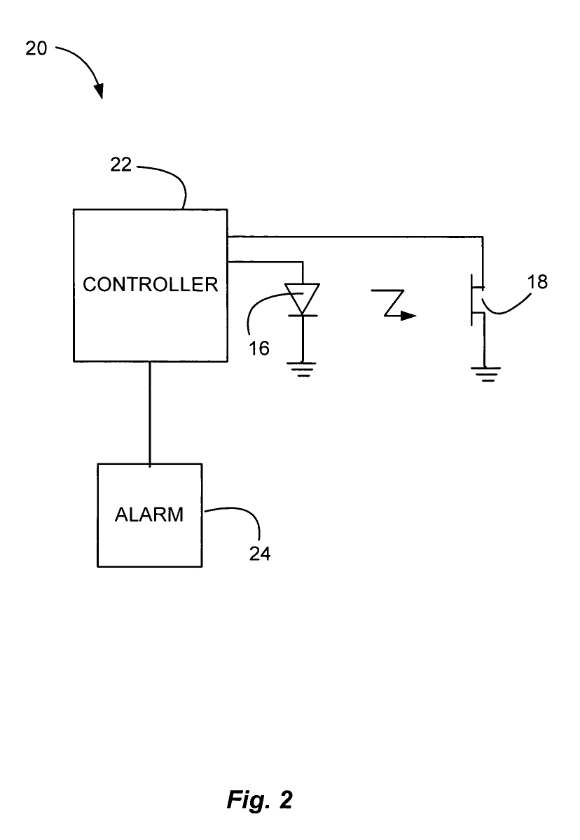

In one embodiment, the tamper detection mechanism also includes a controller 22 connected to emitter 16 and sensor 18. One such embodiment is shown in FIG. 2, where tamper detection controller 22 is connected to emitter 16 and sensor 18. In one such embodiment, tamper detection controller 22 drives emitter 16 with a signal and monitors sensor 18 to determine if it sensor 18 received an input from emitter 16 representative of that signal. In one embodiment, controller 22 looks for an inverted version of the signal (in order to prevent someone from simply shorting the input of emitter 16 to the output of sensor 18).

In one embodiment, tamper detection controller 22 provides the signals which turn on and off emitter 16. In one embodiment, tamper detection controller 22 is a microcontroller such as a PIC microcontroller available from Microchip Technology Inc. of Itasca, Ill. In one such embodiment, the PIC microcontroller is packaged with EEPROM as a Basic Stamp. Such embodiments are available from Parallax, Inc. of Rocklin, Calif. In one embodiment, controller is a PIC12C508.

In one embodiment, controller 22 is connected to an alarm 24, such as a speaker. In the case of the speaker, in the event that no signal is detected after controller 22 stimulates emitter 16, controller 22 sends an appropriate signal to the speaker to cause it to make an audible sound.

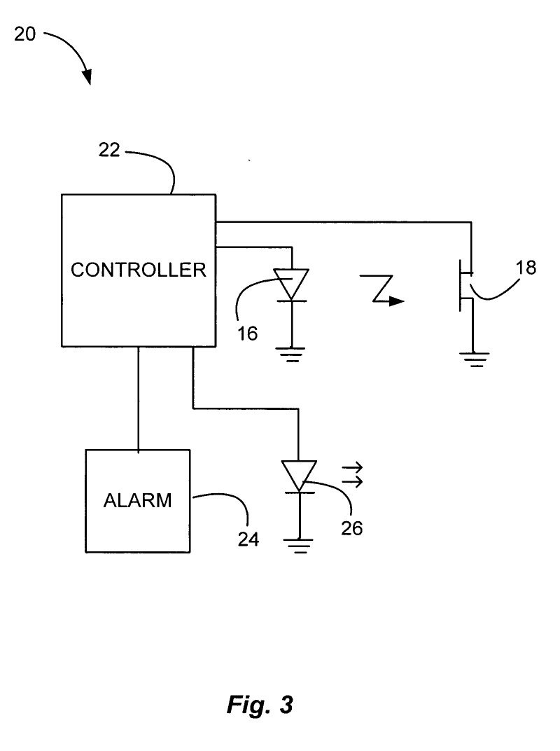

In one embodiment, such as is shown in FIG. 3, controller 22 is also connected to a light emitting diode (LED) 26. LED 26 is used to indicate that door 14 is oriented such that light from emitter 16 is falling on sensor 18. In one such embodiment LED 26 can be viewed through a slit in housing 12 or in door 14 in order to ascertain that the tamper detection mechanism 20 is operating correctly.

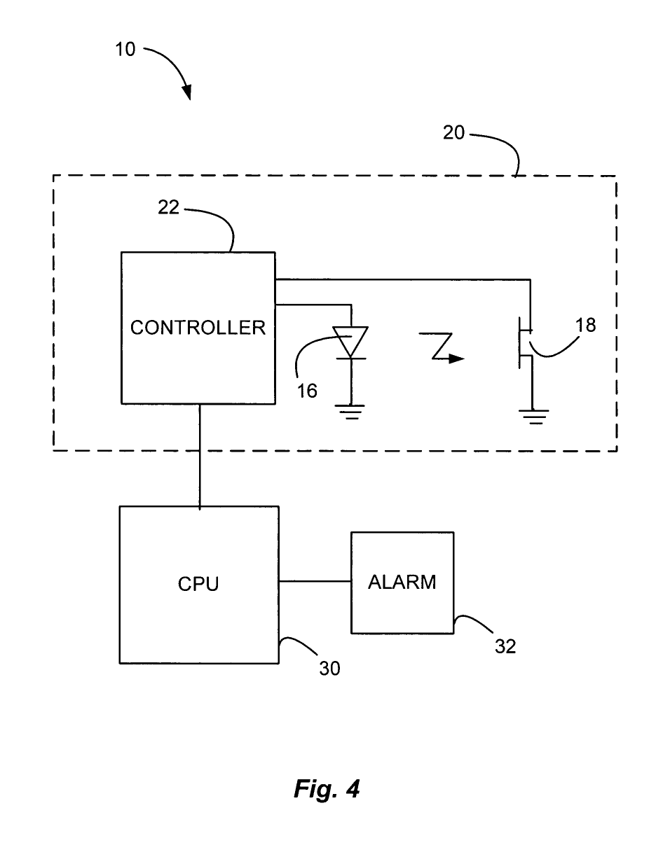

Tamper detection mechanisms 20 of FIGS. 2 and 3 have the advantage that they are stand-alone solutions that can be added to existing machines without having to modify much, if anything, in machine 10. There may, however, be situations where tamper detection mechanism 20 can be added to existing machines 10 in order to leverage existing systems. One embodiment of such an approach is shown in FIG. 4.

In the embodiment shown in FIG. 4, tamper detection mechanism 20 is connected to an existing CPU 30. In one such embodiment, CPU 30 is connected to controller 22 over a serial interface such as a serial port or USB. In another embodiment, CPU 30 includes programmable I/O ports which are used to communicate with controller 22. In yet another embodiment, CPU 30 communicates with controller 22 using unused signal lines such as RTS and CTS.

In one embodiment, controller 22 is mounted as a separate module within housing 12.

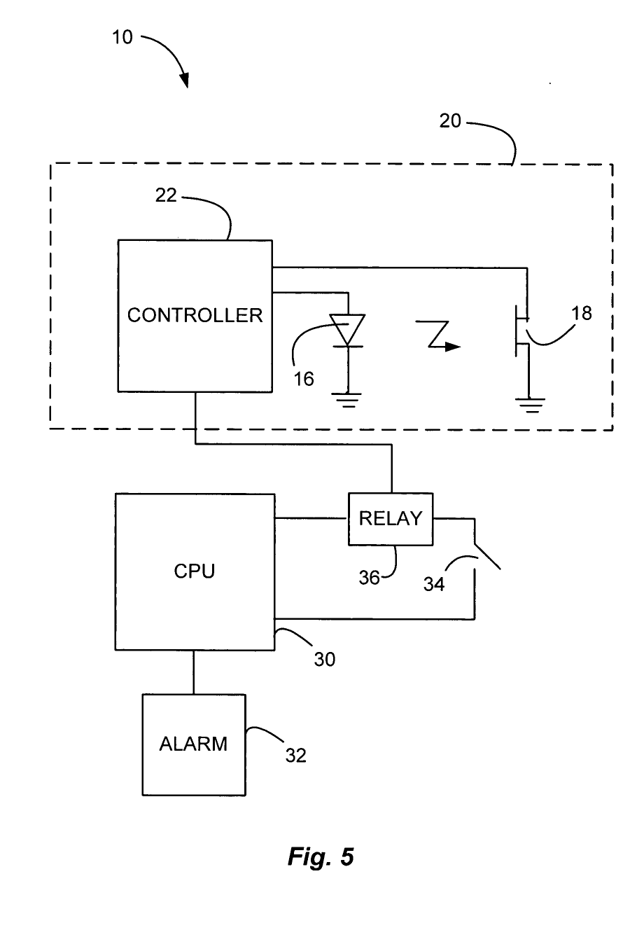

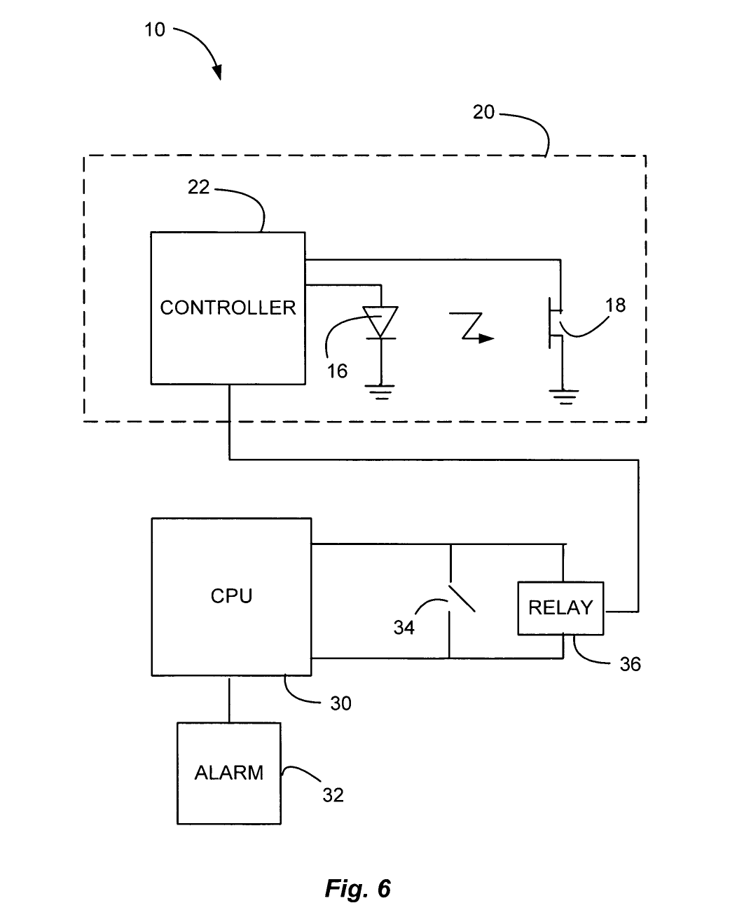

In the embodiment shown, CPU 30 is connected to alarm 32. When controller 22 detects that, for instance, door 14 is open, it signals CPU 30 and CPU 30 raises an alarm using alarm 32. As above, alarm 32 may include a speaker, light or other mechanism for notifying employees of a problem. Tamper detection mechanism 20 can be used advantageously in retrofitting machines 10 with existing intrusion detection mechanisms. Examples of such retrofits are shown in FIGS. 5 and 6, where an existing door monitor is modified to add optical tamper detection. One such switch-based door monitor is described in U.S. Pat. No. 6,420,972, issued Jul. 16, 2002 to Loose, the description of which is incorporated herein by reference.

In the embodiment shown in FIG. 5, machine 10 includes CPU 30 connected to a switch 34 mounted on door 14 and housing 12 such that the switch opens when door 14 is opened. In the embodiment shown, machine 10 is retrofitted to add tamper detection mechanism 20 as described above. In contrast to the embodiment shown in FIG. 4, in this embodiment a relay 36 is added in series to switch 34 such that, when controller 22 detects door 14 is open, relay 36 opens. CPU 30 detects that the circuit is broken and raises an alarm.

In one embodiment, controller 22 is mounted as a module within housing 12 separate from the module housing CPU 30.

In the embodiment shown in FIG. 6, machine 10 includes CPU 30 connected to a switch 34 mounted on door 14 and housing 12 such that the switch closes when door 14 is opened. In the embodiment shown, machine 10 is retrofitted to add tamper detection mechanism 20 as described above. In contrast to the embodiment shown in FIG. 4, in this embodiment a relay 36 is added in parallel to switch 34 such that, when controller 22 detects door 14 is open, relay 36 closes, completing the circuit. CPU 30 detects that the circuit is completed and raises an alarm.

In one embodiment, controller 22 is mounted as a module within housing 12 separate from the module housing CPU 30.

Tamper detection mechanism can be used to detect movement of any object relative to another object within housing 12 of machine 10. For instance, one of emitter 16 and sensor 18 could be mounted to a peripheral (such as a hopper, coin acceptor or cash box) within housing 12 in order to detect movement of the hopper in the manner as described above. What has therefore been described is a system and method of detecting tampering with objects within the housing of a gaming machine. One of an emitter and a sensor is mounted to the housing and one of the emitter and the sensor is mounted to the object, wherein mounting includes positioning the emitter and sensor such that radiation generated by the emitter falls on the sensor when the object is in a particular position and to a lesser extent otherwise. A signal is generated by CPU 30 or controller 22 and emitter 16 is driven with the signal. Controller 22 or CPU 30 then monitor sensor 18 for an inverted version of the signal and generate an alarm if the inverted version of the signal is not detected.

The method as described above can be used advantageously to retrofit a machine 10 as described above. In one such embodiment, an existing gaming machine signal is connected through the module containing tamper detection controller 22 in order to detected tampering with tamper detection mechanism 20. If the module containing tamper detection controller 22 is removed, the existing gaming signal is disconnected, causing an error or alarm. In one such embodiment, the line connecting CPU 30 to switch 34 is connected through the module containing controller 22. This approach has the added advantage of allowing one to place relay 36 on the same circuit board used for controller 22.

A variety of signals can be used to drive emitter 16. The simplest would be to drive emitter 16 with signal that changes state periodically from a logic HIGH to a Logic LOW. In one such approach, controller 22 would change state, wait for the signal to propagate through emitter 16 and sensor 18 and check to see that the signal received from sensor 18 changed state as well. In one such embodiment, controller 22 checks for a logic HIGH when driving emitter 16 with a logic LOW, and vice versa. Other more complex signals could be used as well.

Tamper detection mechanism could be distributed as a kit. One such kit would include an emitter 16, a sensor 18 and a controller 22. In one such embodiment, each of emitter 16, sensor 18 and controller 22 include hardware used to connect them to housing 12. Tamper detection controller 22, when installed in the gaming machine, generates a signal, drives the emitter with the signal, monitors the sensor for an inverted version of the signal and generates an alarm if the inverted version of the signal is not detected. In one such embodiment, controller 22 includes a positioning circuit which lights a light emitting diode (LED) visible to the outside when the emitter and sensor are aligned properly. In another such embodiment, controller 22 includes a positioning circuit which lights a light emitting diode (LED) visible to the outside when the emitter and sensor are not aligned properly.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this documents and those documents so incorporated by reference, the usage in the incorporated reference(s) should be considered supplementary to that of this document; for irreconcilable inconsistencies, the usage in this document controls.

1. A self-service machine, comprising:
a housing;
a door mounted to the housing for gaining access to the inside of the housing;
a processor; and
a tamper detection mechanism, wherein the tamper detection mechanism includes:
a tamper detection controller;
an emitter; and
a sensor,
wherein one of the emitter and sensor is mounted to the housing and one of the emitter and sensor is mounted to the door; and
wherein the tamper detection controller drives the emitter with a signal and monitors the sensor to determine if it generated an inverted version of the signal.

2. The self-service machine according to claim 1, wherein the tamper detection controller is mounted physically separate from the processor.

3. The self-service machine according to claim 1, wherein the emitter is mounted to a portion of a door interlock mechanism.

4. The self-service machine according to claim 1, wherein the sensor is mounted to a portion of a door interlock mechanism.

5. The self-service machine according to claim 1, wherein the sensor and emitter operate to generate an inverted signal and wherein the tamper detection controller generates an alarm if the signal received from the sensor is not inverted.

6. The self-service machine according to claim 1, wherein the tamper detection mechanism further includes a relay.

7. A gaming machine, comprising:
a housing;
a door mounted to the housing for gaining access to the inside of the housing;
a gaming mechanism;
a door interlock mechanism connected to the housing and the door, wherein the door interlock mechanism includes means, connected to the door interlock mechanism, for generating an alarm when the door is open; and
a tamper detection mechanism, wherein the tamper detection mechanism includes:
a tamper detection controller;
an emitter; and
a sensor,
wherein one of the emitter and sensor is mounted to the housing and one of the emitter and sensor is mounted to the door; and
wherein the tamper detection controller drives the emitter with a signal, monitors the sensor for a version of the signal and generates an alarm if the version of the signal is not received as expected.

8. The gaming machine according to claim 7, wherein the emitter is mounted to a portion of the door interlock mechanism.

9. The gaming machine according to claim 7, wherein the sensor is mounted to a portion of the door interlock mechanism.

10. The gaming machine according to claim 7, wherein the sensor and emitter operate to generate an inverted signal and wherein the tamper detection controller generates an alarm if the signal received from the sensor is not inverted.

11. The gaming machine according to claim 7, wherein the tamper detection controller is mounted physically separate from the gaming mechanism.

12. The self-service machine according to claim 7, wherein the tamper detection mechanism further includes a relay.

13. A method of detecting tampering with objects within the housing of a gaming machine, the method comprising:
mounting one of an emitter and a sensor to the housing and one of the emitter and the sensor to the object, wherein mounting includes positioning the emitter and sensor such that radiation generated by the emitter falls on the sensor when the object is in a particular position and to a lesser extent otherwise;
generating a signal;
driving the emitter with the signal;
modifying the signal;
monitoring the sensor for the modified version of the signal; and
generating an alarm if the modified version of the signal is not detected.

14. The method of claim 13, wherein installing a tamper detection controller further includes running an existing gaming machine signal through the tamper detection controller.

15. The method of claim 14, wherein the method further comprises generating an alarm if the existing gaming machine signal is not detected.

16. The method of claim 13, wherein modifying includes inverting the signal.

17. A method of retrofitting a gaming machine in order to detect tampering with objects within the housing of the gaming machine, the method comprising:
mounting one of an emitter and a sensor to the housing and one of the emitter and the sensor to the object, wherein mounting includes positioning the emitter and sensor such that radiation generated by the emitter falls on the sensor when the object is in a particular position and to a lesser extent otherwise;
installing a tamper detection controller, wherein installing includes connecting the tamper detection controller to the emitter and the sensor;
generating a signal at the tamper detection controller and driving the emitter with the signal;
monitoring the sensor for an inverted version of the signal; and
generating an alarm if the modified version of the signal is not detected.

18. The method of claim 16, wherein installing a tamper detection controller further includes running an existing gaming machine signal through the tamper detection controller.

19. The method of claim 17, wherein the method further comprises generating an alarm if the existing gaming machine signal is not detected.

20. A kit for retrofitting a self-service machine in order to detect tampering with objects within the housing of the self-service machine, the kit comprising:
a tamper detection controller, wherein the tamper detection controller includes means for installing the controller within the housing;
an emitter, wherein the emitter generates radiation in response to a driving signal; and
a sensor capable of generating a signal as a function of radiation falling on the sensor;
wherein the emitter and the sensor include means for positioning the emitter and sensor within the housing such that radiation generated by the emitter falls on the sensor when the object is in a particular position and to a lesser extent otherwise; and
wherein the tamper detection controller, when installed in the gaming machine, generates a signal, drives the emitter with the signal, monitors the sensor for an inverted version of the signal and generates an alarm if the inverted version of the signal is not detected.

21. The kit according to claim 20, wherein the positioning means includes a light emitting diode (LED) used to align the emitter and sensor.

22. The kit according to claim 21, wherein the LED is lit when the emitter and sensor are not aligned properly.

23. The kit according to claim 19, wherein the object is a peripheral.

24. The kit according to claim 19, wherein the peripheral is a hopper.

25. The kit according to claim 19, wherein the object is a door.

26. A tamper detection system for increasing detection of tampering of an object associated with a self-service machine having a housing, the system comprising:
means for mounting one of an emitter and a sensor to the housing and one of the emitter and the sensor to the object, wherein mounting includes positioning the emitter and sensor such that radiation generated by the emitter falls on the sensor when the object is in a particular position and to a lesser extent otherwise;
means for generating a signal;
means for driving the emitter with the signal;
means for modifying the signal;
means for monitoring the sensor for a modified version of the signal; and
means for generating an alarm if the modified version of the signal is not detected.

27. The method of claim 26, wherein installing a tamper detection controller further includes running an existing gaming machine signal through the tamper detection controller.

28. The method of claim 27, wherein the method further comprises generating an alarm if the existing gaming machine signal is not detected.

29. The method of claim 28, wherein modifying includes inverting the signal.
